(19) United States
(12) Patent Application Publication
(10) Pub. No.: US 2015/0024087 A1
(43) Pub. Date: Jan. 22, 2015

(54) METHOD FOR PREPARING A HYPOALLERGENIC FOOD

(71) Applicants: SOCIETE FINANCIERE CORMOULS HOULES, Saint-Jean (FR); UNIVERSITE PAUL SABATIER TOULOUSE III, Toulouse (FR); CENTRE NATIONAL DE LA RECHERCHE SCIENTIFIQUE, Paris (FR)

(72) Inventors: Etienne Brunet, Toulouse (FR); Annick Barre, Toulouse (FR); Stephanie Caze-Subra, Toulouse (FR); Nicolas Cormouls-Houles, Toulouse (FR); Vincent Le Mouel, Toulouse (FR); Pierre Rouge, Auzeville-Tolosane (FR)

(21) Appl. No.: 14/375,755

(22) PCT Filed: Feb. 1, 2013
(86) PCT No.: PCT/EP2013/052097

§ 371 Date: Jul. 30, 2014

(30) Foreign Application Priority Data
Feb. 2, 2012 (FR) 12 50977

(51) Int. Cl. A23L 1/211

(52) U.S. Cl. CPC A23L 1/2113; A23L 1/2118; A23V 2002/00
USPC 426/60; 426/519; 426/7

(57) ABSTRACT

A method for preparing a food that is less allergenic from a particulate solid food matrix that is more allergenic and contains allergenic proteins, in particular a peanut and/or tree-nut matrix. The method comprises the step of processing dispersion of the solid food matrix in an aqueous medium by high-pressure homogenization to obtain a homogenate consisting of a dispersion of allergenic proteins initially contained in the matrix mixed with solid particles of the matrix. The homogenization step can be preceded by a step of grinding the matrix, and followed by a step of processing the homogenate with a protein-degrading agent, in particular with a probiotic microorganism.

The present invention falls within the field of the preparation of hypoallergenic foods. More particularly, it relates to a method for preparing a food that is less allergenic from a solid food matrix that is more allergenic, in particular from a food matrix based on peanut seeds and/or tree nuts.

The World Health Organization currently ranks allergies 3rd among the most widespread chronic diseases worldwide. In industrialized countries, it is estimated that they affect close to one individual in three, and a proportion of one individual in two can be envisioned by 2030 should the increase in cases of allergy recorded during the past ten years continue at the same rate. Food allergies represent approximately 5% of allergies, and up to 10% in children. They have been constantly increasing for several years.

In particular, peanut and tree nut (walnut, hazelnut, cashew nut, pecan nut, pistachio nut, etc.) allergies occupy an important place in the food allergy category owing to their high prevalence and especially their seriousness. They are frequently reflected by oropharyngeal edema or systemic anaphylactic shocks. These allergies consequently require adherence to a strict diet, excluded from which are all products that may contain peanut or tree nuts. Some European or international regulations require the presence of these products to be mentioned on food labels. The major allergens in question in these allergies correspond essentially to storage proteins, which accumulate in appreciable amounts in the maturing seeds, and which are indissociable from the seed. During seed germination, these storage proteins have the role of providing the young plant with the amino acids required for its growth.

Defined herein as major allergens are the allergens for which at least 50% of allergic individuals possess the corresponding IgE antibodies. Most of the major peanut and tree nut protein allergens have to date been identified. These major allergens correspond essentially to vicilins, legumins and 2S albumins.

For example, to date, eleven different allergenic proteins have been identified in peanut, called Ara h 1 to Ara h 11. Among them, Ara h 1 (vicilin having a molecular weight of 63.5 kDa) and Ara h 2 (2S albumin having a molecular weight of 16-17 kDa) represent, respectively, approximately 12% to 16%, and 6% to 9%, of the peanut proteins. More than 95% of individuals allergic to peanut have IgE antibodies specific for these two proteins. Ara h 3, which is a legumin, has also been identified as a major peanut allergen.

Various methods for reducing the degree of allergenicity of foods based on raw materials that are highly allergenic, in particular based on peanut, have been proposed by the prior art.

By way of example, mention may be made of genetic improvement, by selection via backcrosses of low-allergen varieties, or the development of genetically modified peanuts with a low allergen content. However, these techniques do not give satisfactory results, insofar as the synthesis and accumulation of the major peanut allergens are governed by multifactor systems, the expression of which is difficult to modify. In addition, modification via genetic engineering techniques comes up against the problem of the use of genetically modified organisms in the food-processing field.

Various methods for physicochemical treatment of peanut seeds have also been proposed, but, at the current time, none has given convincing results, whether it is a question in particular of heat treatment (Davis et al., 1998), UV radiation treatment (Chung et al., 2008), treatment with digestive proteases such as trypsin or pepsin (van Boxtel et al., 2008) or treatment by addition of other compounds, such as complexing agents, for example phytic acid (Chung et al., 2007).

The prior art, in particular in the scientific publication by Kato et al. (Kato, 2000), or in the patent documents WO 92/11772, JP 3 653132 and U.S. Pat. No. 5,476,677, has otherwise proposed methods for reducing the allergenicity of certain seeds, more particularly of rice and of cereals, by treating these seeds by hydrostatic pressurization, aimed at releasing the allergenic proteins which are contained therein. However, these methods make it possible to release only a part of these allergenic proteins, which is all the lower when the latter are not naturally very available for extraction, since they are present in the seeds in the form of compact protein bodies.

The present invention aims to remedy the drawbacks of the methods for preparing weakly allergenic foods which are proposed by the prior art, in particular those set out above, by proposing such a method which makes it possible to obtain, from a solid food matrix which is naturally highly allergenic, a food which is much less allergenic, or even not at all allergenic.

An additional objective of the invention is for this method to be non-polluting in addition to being food-compatible, and in particular for it to use no solvent or ionizing additive, so as to entirely respect not only the innocuousness but also the gustative and nutritional properties of the initial food matrix.

To this effect, the present invention provides a method for preparing a food that is less allergenic from a particulate solid food matrix that is more allergenic and contains allergenic proteins. This method comprises a step of treating a dispersion of the solid food matrix in an aqueous vehicle, by means of high-pressure, preferably ultra high-pressure, homogenization, i.e. under hydrodynamic conditions, so as to obtain a homogenate consisting of a dispersion of allergenic proteins initially contained in the matrix, as a mixture with solid particles of the matrix. Advantageously, this step makes it possible to extract from the matrix virtually all the allergenic proteins that were initially contained therein, and in particular all of the major allergens.

The term “particulate” is intended to mean herein that the solid food matrix is made up of particles, without any size limitation for these particles. Thus, the term “particles” encompasses herein whole seeds, grains, nuts, etc., whatever their size. This term also encompasses, for example, cells, cell organelles, etc.

The term “solid food matrix” is intended to mean an edible raw material in solid form, in particular of plant origin, or a solid derivative of such a raw material. Preferentially, the solid food matrix is, or is based on, a crude raw material, i.e. one which has not undergone any step for purification or separation of its components. More particularly, the solid food matrix may consist of food seeds which are allergenic, in particular of seeds of peanut and/or of tree nuts such as walnuts, hazelnuts, cashew nuts, pecan nuts, macadamia nuts, brazil nuts, pistachio nuts, almonds, pine nuts, sweet chestnuts, etc.

Alternatively, the solid food matrix may consist of cereal products such as wheat, barley, rye, oats, spelt, quinoa, etc.; of seeds of leguminous plants such as peas, lentils, beans, soya, etc.; any other seeds, such as sesame, buckwheat or fenugreek seeds; or be based on such products. The food matrix may also be made up of fruits other than those with a shell (tree nuts), such as apples, grapes, etc., it being possible for said fruits to have undergone transformation steps prior to the implementation of the method according to the invention, for example steps of peeling, slicing, cutting up, etc.

When the solid food matrix is based on peanut, it may consist of any form of the peanut, whether this is the crude or roasted seeds, or derived products, in particular peanut butter or peanut flour. The same is true when the food matrix is based on tree nuts and/or on cereals, it being possible for the matrix to then consist of any form of the tree nut and/or of the cereal, whether they are crude or have undergone a heat treatment, or else of any product which is derived therefrom.

Allergenicity is conventionally in itself defined herein as the capacity of a substance to cause an allergic reaction, i.e. a problematic reaction of the immune system in certain subjects who show hypersensitivity with regard to this substance. The allergic reaction involves several antibodies, including immunoglobulins E (IgE), a specific class of immunoglobulins secreted by B lymphocytes. In the presence of the allergen, which is a biological or chemical substance recognized by the human immune system that causes an allergic reaction or response, the antibody triggers the release of chemical mediators which cause the allergic reaction, possibly resulting in various more or less serious symptoms such as itching, skin rashes, trouble breathing, vomiting, diarrhea, oropharyngeal edema or a systemic anaphylactic reaction (anaphylactic shock).

The high-pressure homogenization technique implemented in the context of the present invention is known in itself, and consists in projecting, at a constant flow rate, a liquid or pasty product, under strong pressure, typically of between 30 and 40,000 bar, through a homogenization head, by means of a space of a few μm left free by a backpressure valve. The pressure upstream of this valve then becomes very strong, and the abrupt decompression downstream of the valve causes phenomena that lead to a modification of the dispersed product, in particular shear, microturbulence and cavitation phenomena. This technique is in particular described as making it possible to stabilize fatty emulsions or to obtain small particle sizes within an emulsion or a dispersion of solids in a liquid phase. The way in which it operates is in particular described in detail in the publication by Lecluse, 1979.

Unexpectedly, it has now been discovered by the present inventors that the treatment by high-pressure homogenization of a dispersion, in an aqueous vehicle, of a solid food matrix makes it possible to solubilize the allergenic proteins contained in this matrix, including when, as in the case of the crude peanut seed, these allergenic proteins are not naturally very available for extraction, since they are included in the matrix in the form of compact protein bodies.

This treatment step, carried out under hydrodynamic conditions, by projection of the dispersion of the food matrix under high pressure through a homogenization head, is in particular found to be much more advantageous than the simple pressurization treatments, under hydrostatic conditions, proposed by the prior art, in terms of amount of allergenic proteins extracted from the matrix.

A subsequent treatment of the homogenate obtained, by degradation of these allergenic proteins, advantageously makes it possible to obtain, directly or after transformation, a hypoallergenic food product which retains intact the initial gustative and nutritional properties of the food matrix.

The term “hypoallergenic” is used herein, with reference to a food, to mean less of a tendency to cause an allergic reaction, compared with the food matrix used as a basis for its preparation. In embodiments of the invention, the method for preparing a food including a step of treatment by high-pressure homogenization of the solid food product, in particular of a crude raw material such as peanut seeds or tree nuts, or more generally any food seed which is allergenic, makes it possible to obtain a considerable solubilization, greater than 95%, of the allergenic proteins initially contained in the matrix. In particular, in the case of peanut seeds, the three major allergenic proteins, Ara h 1, Ara h 2 and Ara h 3, are thus advantageously almost totally solubilized in the aqueous vehicle. This results, after a subsequent step of degradation of these proteins, in a significant decrease, up to more than 90%, in the allergenicity of these allergenic proteins.

We will not judge herein what the mechanisms underlying such an advantageous result might be. In the particular case of peanut seeds, the allergenic proteins are stored in the seed vacuoles which, once saturated, are then dehydrated to form the protein bodies. This dehydration results in a packaging of the proteins which then become arranged in pseudo-crystalline structures, thus making them not very available for extraction with the buffers commonly used to solubilize proteins. It can be assumed that the high-pressure homogenization treatment, by destructuring the solid food matrix, increases the availability and the degree of solvation of these proteins, and also their susceptibility to undergoing biological and chemical modifications aimed at denaturing and degrading them.

The allergenicity of the food obtained can be evaluated by any means known to those skilled in the art, in particular by quantification of its major-allergen content using immunological assays, for example by means of the technique known as ELISA (Enzyme-Linked ImmunoSorbent Assay), using antibodies specific for these allergens.

According to preferred embodiments, the invention also satisfies the following characteristics, implemented separately or in each of their technically effective combinations.

In particular, the choice of the preferential operating parameters is carried out so as to obtain the best yield of extraction of the allergenic proteins contained in the solid food matrix during the high-pressure homogenization step.

In embodiments of the invention, the solid food matrix is subjected to a grinding step prior to the high-pressure homogenization treatment step, preferably after its dispersion in the aqueous vehicle. Such a characteristic advantageously improves the yield of extraction of the allergenic proteins contained in the matrix, in particular when the matrix initially consists of seeds or whole grains with a relatively large diameter.

Preferentially, this grinding is carried out so as to obtain a solid matrix particle size of less than 1500 μm, in terms of diameter of the particles of which it is composed.

To this effect, a rotor mixer, which is conventional in itself, may in particular be used, said mixer making it possible, by virtue of shear forces, to reduce the particle size of the solid matrix and to roughly disperse the solid particles in the aqueous vehicle.

The grinding can be carried out at a temperature of between 15 and 90° C., preferably approximately equal to 25° C. The speed of the rotor can be adjusted to a value of between 100 and 10 000 revolutions/minute, preferably to approximately 800 revolutions/minute. The duration of the grinding may be between 2 and 60 minutes, and is preferentially approximately 10 minutes.

In particular embodiments of the invention, the dispersion of solid food matrix in the aqueous vehicle comprises a ratio of weight of solid food matrix to volume of aqueous vehicle of between 50/50 and 5/95, and preferably equal to 20/80.

The aqueous vehicle is preferentially water.

According to an advantageous characteristic of the invention, the high-pressure homogenization treatment step is carried out at a pressure of between 100 and 50,000 bar, preferably between 200 and 1000 bar, preferentially at approximately 500 bar.

The high-pressure homogenization can be carried out at a temperature of between 15 and 90° C., preferentially at approximately 35° C.

In preferred embodiments of the invention, the high-pressure homogenization treatment step is carried out so as to obtain a homogenate particle size of less than 20 μm, preferably approximately equal to 10 μm, in terms of diameter of the particles of which it is composed. The obtaining of such a particle size is advantageously associated with an optimum yield of extraction of the allergenic proteins from the matrix. It is also compatible with the high-pressure homogenizers commonly provided on the market.

A single high-pressure homogenization cycle is generally sufficient to obtain a yield of extraction of the allergenic proteins from the solid food matrix of greater than 95%, whatever the initial state of these proteins in the matrix.

At the end of this high-pressure homogenization step, a dispersion free of any particle detectable with the naked eye, which retains the initial flavor of the starting solid food matrix, is obtained.

In preferred embodiments of the invention, the high-pressure homogenization treatment step is followed by a step of treating the obtained homogenate with a protein-degrading/denaturing agent, so as to degrade the allergenic proteins contained in the homogenate and to thus reduce their allergenicity, preferably by at least 70%, preferentially by at least 90%, and more preferentially by at least 95%.

The protein-degrading agent may be a chemical or biological agent, in particular a proteolytic agent, which may be derived from a microorganism, and in particular a protease. In particular, biological agents are particularly preferred in the context of the invention

The protein-degrading agent may be a microorganism, the enzymatic, in particular proteolytic, activity of which may be greater than those of the isolated enzymes, and preferably a probiotic microorganism. The term “probiotic” is intended to denote living microorganisms which, when they are integrated in sufficient amount, exert a positive effect on health, beyond the normal nutritional effects.

Recourse to chemical agents or solvents is thus advantageously avoided for this step of the preparation of the hypoallergenic food.

The microorganisms selected according to the invention may be bacteria or single-cell fungi such as yeasts or multicellular fungi.

Preferentially, they are chosen so as to have organoleptic properties such that they do not modify the initial gustative qualities of the homogenate.

Examples of species of bacteria which may be used in the context of the invention are Lactobacillus plantarum and Bacillus subtilis. Examples of fungi are Saccharomyces cerevisiae, Rhizopus oligosporus and Aspergillus oryzae.

One or more microorganisms of different species or genera may be used simultaneously or consecutively.

In preferred embodiments of the invention, the microorganism is inoculated into the homogenate, and the resulting medium is left to ferment for a period of time sufficient to reduce by at least 70%, preferably by at least 90%, the allergenicity of the allergenic proteins initially contained in the homogenate.

The initial amount of microorganisms used for the inoculation and the fermentation conditions are in particular determined according to the starting solid food matrix and the allergenic proteins that it contains.

Preferentially, when the microorganism is a fungus, the inoculation is carried out in a proportion of from 1×10⁴ to 1×10⁸ spores per ml of homogenate. When the microorganism is a bacterium, the inoculation is, for example, carried out by means of a bacterial culture with an optical density at 600 nm of approximately 0.5, which is added to the homogenate in a concentration of from 10% to 70% by volume, preferentially of approximately 50% by volume. Such a choice of inoculation conditions advantageously makes it possible to obtain the best activity of degradation of the allergenic proteins contained in the homogenate by the microorganism.

The fermentation can be carried out in an aerated system, with an orbital shaking, at a temperature of between 20 and 45° C., preferably of approximately 37° C., for 2 to 300 hours, preferably for approximately 72 hours.

Before inoculation, the homogenate is preferably brought to a temperature of greater than or equal to 100° C., for 10 to 30 minutes, and then cooled to ambient temperature.

In the embodiments of the invention, the homogenate is supplemented with sugar, for example sucrose, glucose, maltose; with starch, for example wheat starch, corn starch or potato starch, in a concentration of between 0.5% and 10% by weight/volume; and/or with acid, such as acetic acid, prior to the fermentation, so as to promote the enzymatic, in particular proteolytic, activity of the microorganism.

More generally, the step of treatment with a probiotic microorganism, for the purpose of reducing the allergenicity of the allergenic proteins contained in a solid matrix, can be carried out on any form of this solid matrix, including on forms which have not been subjected to high-pressure homogenization, but which have been subjected to any other type of prior treatment, or to no such prior treatment. In particular, this step of treatment with a probiotic microorganism can be carried out on a dispersion of particles and proteins derived from the solid matrix, obtained by a technique other than high-pressure homogenization. The characteristics of this step of treatment with a probiotic microorganism can then be as described above.

The fermentate obtained at the end of the fermentation can advantageously be used as a food as such, or as an intermediate for producing a food.

For example, when the initial solid food matrix is made from peanut, the fermentate can, after optional dehydration, be incorporated into peanut oil, in particular refined peanut oil, which is not in itself allergenic in nature, for the preparation of peanut butter.

The final food is much less allergenic than the initial solid food matrix, this reduction in allergenicity possibly being as much as higher than 95%. Its gustative, organoleptic and nutritional qualities are similar to those of this matrix.

The method according to the invention constitutes a major advance in the daily management of food evictions imposed on allergic individuals and the problems associated therewith, in particular regarding the labeling of food products.

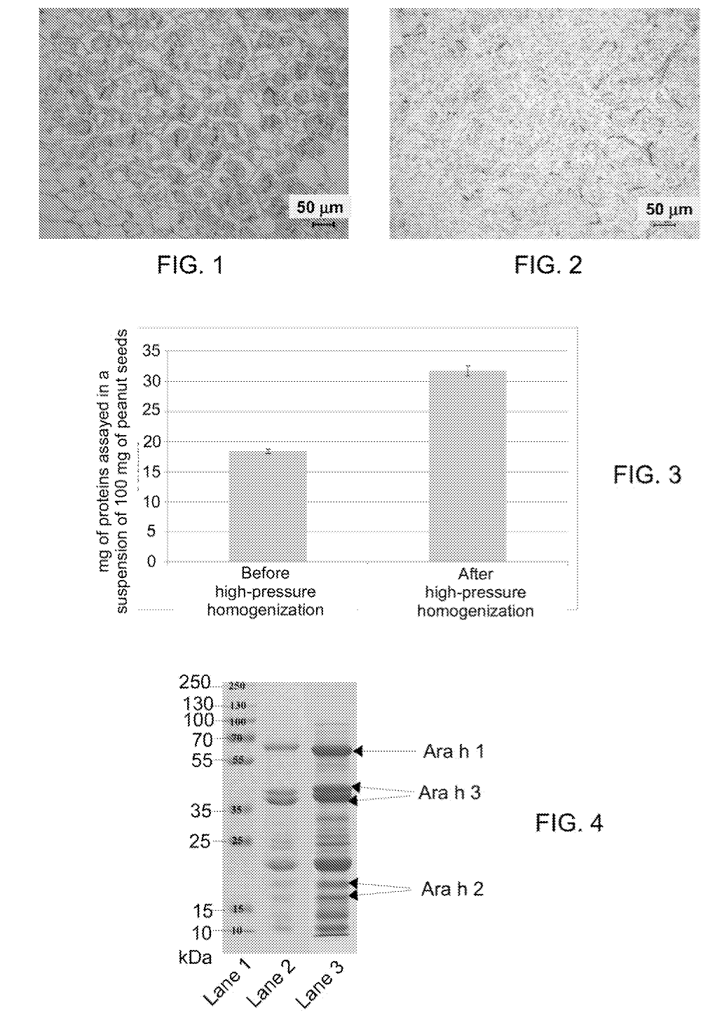

The characteristics and advantages of the method according to the invention will become more clearly apparent in the light of the exemplary embodiments hereinafter, provided simply by way of illustration and which are in no way limiting on the invention, with the support of FIGS. 1 to 10, in which:

FIG. 1 represents a micrograph at 20× magnification of particles obtained by grinding raw peanut seeds in accordance with particular embodiments of the invention;

FIG. 2 shows a micrograph at 20× magnification of particles of a homogenate obtained from raw peanut seeds according to one particular embodiment of the method according to the invention;

FIG. 3 is a histogram showing the weight in mg of proteins assayed in a suspension of 100 mg of raw peanut seeds, respectively before and after a homogenization step according to one particular embodiment of the invention;

FIG. 4 shows an SDS-PAGE (Sodium Dodecyl Sulfate-PolyAcrylamide Gel Electrophoresis) gel stained with Coomassie blue, obtained after migration of: Lane 1, a molecular weight marker; Lane 2, an extract of a suspension of peanut seeds after grinding and before high-pressure homogenization; and Lane 3, an extract of a suspension of peanut seeds after high-pressure homogenization in accordance with particular embodiments of the invention;

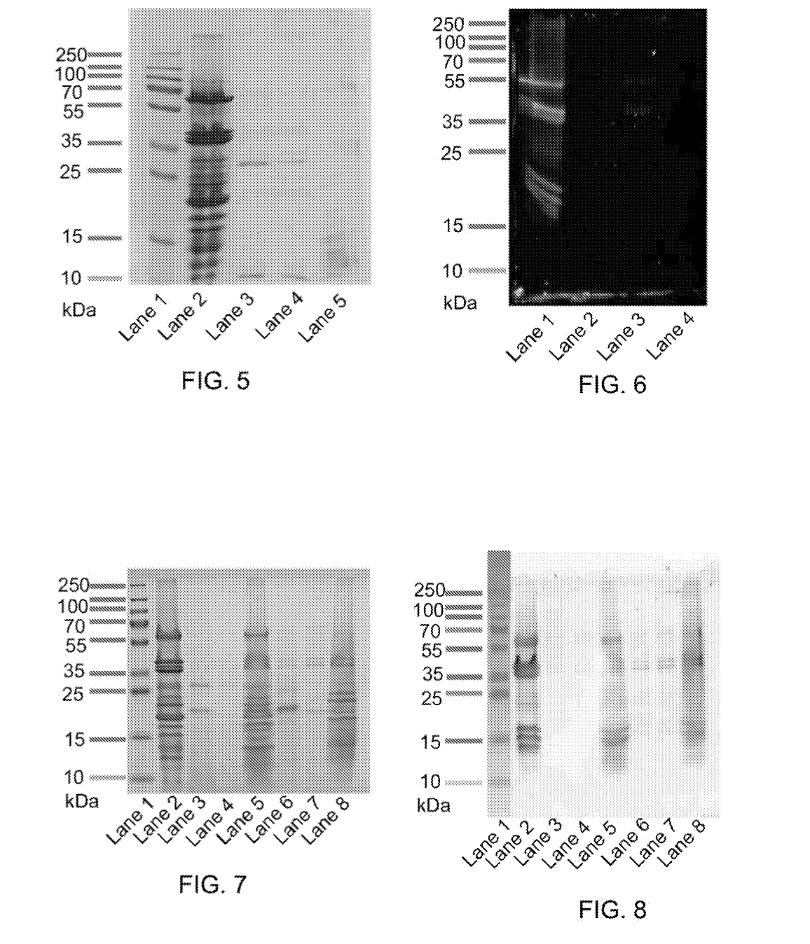

FIG. 5 shows an SDS-PAGE gel stained with Coomassie blue, obtained after migration of: Lane 1, a molecular weight marker; Lane 2, a crude protein extract of untreated raw peanut seeds; Lanes 3 to 5, protein extracts obtained from raw peanut seeds by means of steps of grinding, high-pressure homogenization, and then 72 hours of fermentation by Rhizopus oligosporus, according to one particular embodiment of the method according to the invention, Supernatant fraction for Lane 3, soluble Fraction for Lane 4 and insoluble Fraction for Lane 5 (20 μg of proteins loaded per well);

FIG. 6 represents an SDS-PAGE gel followed by a Western blot obtained after migration of: Lane 1, a crude protein extract of untreated raw peanut seeds; Lanes 2 to 4, protein extracts obtained from raw peanut seeds by means of steps of grinding, high-pressure homogenization, and then 72 hours of fermentation by Rhizopus oligosporus, according to one particular embodiment of the method according to the invention, Supernatant fraction for Lane 2, soluble Fraction for Lane 3 and insoluble Fraction for Lane 4 (20 μg of proteins loaded per well, pool of rabbit anti-Ara h 1, anti-Ara h 2, anti-Ara h 3 antibodies); the molecular weight marker is represented on the left in the figure;

FIG. 7 shows an SDS-PAGE gel stained with Coomassie blue, obtained after migration of: Lane 1, a molecular weight marker; Lane 2, a crude protein extract of untreated raw peanut seeds; Lanes 3 to 5, protein extracts obtained from raw peanut seeds by means of steps of grinding, high-pressure homogenization, and then 72 hours of fermentation by Aspergillus oryzae, according to one particular embodiment of the method according to the invention, Supernatant fraction for Lane 3, soluble Fraction for Lane 4 and insoluble Fraction for Lane 5; Lanes 6 to 8, protein extracts obtained from roasted peanut seeds by means of steps of grinding, high-pressure homogenization, and then 72 hours of fermentation by Aspergillus oryzae, according to the same embodiment of the method according to the invention, Supernatant fraction for Lane 6, soluble Fraction for Lane 7 and insoluble Fraction for Lane 8 (20 μg of proteins loaded per well);

FIG. 8 represents an SDS-PAGE gel followed by a Western blot obtained after migration of: Lane 1, a molecular weight marker; Lane 2, a crude protein extract of untreated raw peanut seeds; Lanes 3 to 5, protein extracts obtained from raw peanut seeds by means of steps of grinding, ultra high-pressure homogenization, and then 72 hours of fermentation by Aspergillus oryzae, according to one particular embodiment of the method according to the invention, Supernatant fraction for Lane 3, soluble Fraction for Lane 4 and insoluble Fraction for Lane 5; Lanes 6 to 8, protein extracts obtained from roasted peanut seeds by means of steps of grinding, ultra high-pressure homogenization, and then 72 hours of fermentation by Aspergillus oryzae, according to the same embodiment of the method according to the invention, Supernatant fraction for Lane 6, soluble Fraction for Lane 7 and insoluble Fraction for Lane 8 (20 μg of proteins loaded per well, pool of rabbit anti-Ara h 1, anti-Ara h 2, anti-Ara h 3 antibodies);

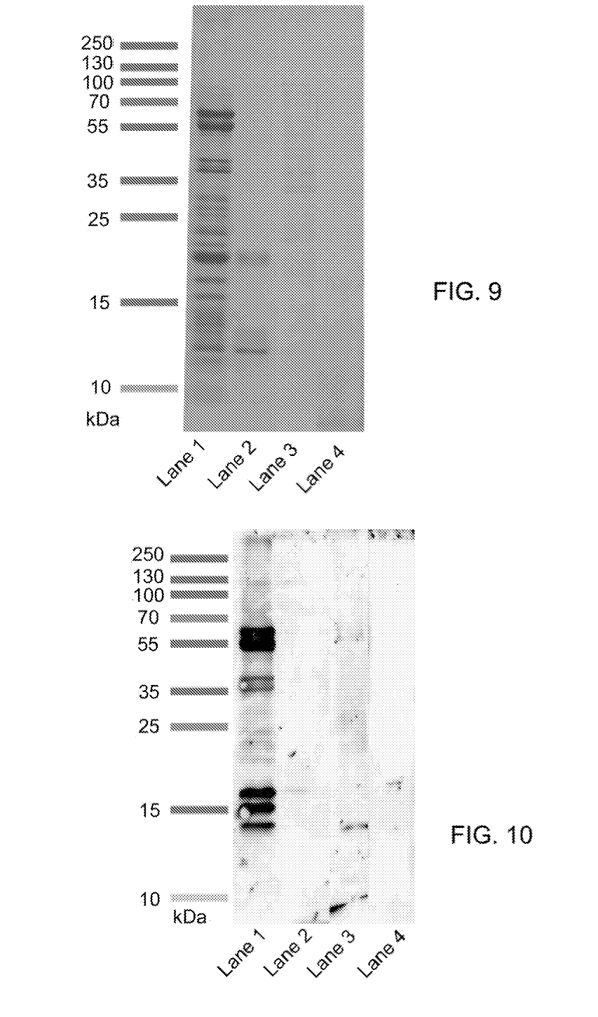

FIG. 9 shows an SDS-PAGE gel stained with Coomassie blue, obtained after migration of: Lane 1, a crude protein extract of untreated raw peanut seeds; Lanes 2 to 4, protein extracts obtained from raw peanut seeds by means of steps of grinding, high-pressure homogenization, and then 72 hours of fermentation by Bacillus subtilis, according to one particular embodiment of the method according to the invention, Supernatant fraction for Lane 2, soluble fraction for Lane 3 and insoluble Fraction for Lane 4 (20 μg of proteins loaded per well); the molecular weight marker is represented on the left in the figure; and

FIG. 10 represents an SDS-PAGE gel followed by a Western blot obtained after migration of: Lane 1, a crude protein extract of untreated raw peanut seeds; Lanes 2 to 4, protein extracts obtained from raw peanut seeds by means of steps of grinding, ultra high-pressure homogenization, and then 72 hours of fermentation by Bacillus subtilis, according to one particular embodiment of the method according to the invention, Supernatant fraction for Lane 2, soluble Fraction for Lane 3 and insoluble Fraction for Lane 4 (20 μg of proteins loaded per well, pool of rabbit anti-Ara h 1, anti-Ara h 2, anti-Ara h 3 antibodies); the molecular weight marker is represented on the left in the figure.

### EXAMPLE A

### Treatment of a Solid Food Matrix Consisting of Crude Peanut Seeds by High-Pressure Homogenization

1) Materials and Methods

A Silverson® high-shear immersion mixer is used for the initial grinding of the matrix. The rotor speed is set at 700 revolutions/minute, the treatment time at 5 minutes. The temperature is approximately 25° C.

The high-pressure homogenization is carried out by means of a Lab-1000 high-pressure homogenizer from the company APV, at a pressure of 500 bar, and at a temperature of 35° C.

The microscopic analysis is carried out on a dispersion of the solid food matrix, respectively after grinding and after high-pressure homogenization. To this effect, 10 μl of the dispersion are deposited on a glass slide and dried at a temperature of 60° C. for 10 minutes. This allows the residual solids to adhere to the glass slide and makes it possible to carry out a staining. The slides are then immersed in a 1% (w/v) acridine orange solution for 5 minutes at ambient temperature. After washing with distilled water, the slides are immersed in a 1% (w/v) Congo red solution for 5 minutes, and then rinsed thoroughly with distilled water. The slides are then immersed in a 1% (w/v) Light green solution for 2 minutes and then rinsed with distilled water. The observation is then carried out under a microscope with a 20× magnification, using a Leica DM IRBE inverted, wide-field, light-background microscope. The staining makes it possible to identify the various components of the dispersion: the starch is stained violet, the proteins green/blue (visible as dark gray on FIGS. 1 and 2) and the cell walls brown/orange.

The assaying of the proteins present in the dispersion is carried out before and after the high-pressure homogenization treatment. To this effect, 20 μl of a tris(2-amino-2-hydroxymethyl-1,3-propanediol) buffer solution at 1 mol/l at a pH of 8.5 are added to 980 μl of the dispersion (at identical weight/volume ratios), in a 1.5 ml Eppendorf tube. The suspensions are then shaken on an orbital shaker at an ambient temperature for 1 h. The tubes are centrifuged at 4° C. at a speed of 16 100 g for 10 minutes, and the supernatant is removed. This supernatant is diluted to 1/10 in ultrapure water, and the proteins are assayed using the BCA (bicinchoninic acid) protein assay kit from Pierce, on a 96-well flat-bottom microplate. The standard range is a solution of BSA (bovine serum albumin) in concentrations ranging from 2 mg/ml to 0 mg/ml. After incubation of the protein solution (25 μl after dilution) and of the kit reagent (200 μl) for 30 minutes at 37° C., the microplate is read on a spectrophotometric reader at a wavelength of 562 nm. The protein concentrations are calculated from the standard range.

The gel separation of the proteins is carried out on a polyacrylamide gel under denaturing conditions (SDS-PAGE). The electrophoreses are carried out in flat 12.5% porosity acrylamide gels. This mesh makes it possible to clearly separate the medium-molecular-weight and low-molecular-weight proteins (between 100 and 10 kDa).

The gels consist of a separating gel (12.5% acrylamide; 0.4% bisacrylamide; 0.125 mol/l Tris-HCl, pH 8.8; 0.1% sodium dodecyl sulfate (SDS)) and a stacking gel (4.8% acrylamide; 0.3% bisacrylamide; 0.375 mol/l Tris-HCl, pH 6.8; 0.1% SDS). The migration is carried out at a constant amperage of 30 mA for approximately 1 hour.

The protein solutions are loaded at constant volume: 1 μl+19 μl of ultrapure water+4 μl of a loading buffer solution [2% SDS; 0.125 M Tris; 10% glycerol; 5% β-mercaptoethanol] and heated for 5 minutes at 100° C. before being loaded onto the gel.

The proteins separated on gels are then stained according to the following protocol, fixing in a solution of 40% ethanol, 10% acetic acid and 50% H₂O for 30 minutes; staining in a solution of Coomassie blue (1 g of R250 Coomassie blue, 250 ml of ethanol, 80 ml of acetic acid, 670 ml of H₂O); destaining in a solution of 25% ethanol, 8% acetic acid, 67% H₂O, until the background of the gel is clear.

2) Results

Crude peanut seeds are suspended in water, in a seed to water volume weight ratio equal to 20/80.

This suspension is subjected to grinding, according to the method indicated above. At the end of this step, a suspension of peanut seed particles in water is obtained.

This suspension is subjected to microscopic analysis, according to the method indicated above. After staining, the micrograph represented on FIG. 1 is obtained. It is observed thereon that all the solid particles have a diameter of less than 1500 μm.

The suspension obtained is subjected to high-pressure homogenization according to the method indicated above (single pass through the homogenizer).

The homogenate obtained is subjected to microscopic analysis, according to the method indicated above. After staining, the micrograph represented on FIG. 2 is obtained. A disaggregation of the protein bodies is clearly observed thereon, compared with the suspension before homogenization which is shown in FIG. 1. Since the vast majority of allergenic peanut proteins, in particular Ara h 1, Ara h 2, Ara h 3/4, Ara h 5, Ara h 6, Ara h 8 and Ara h 9, are contained in these protein bodies, it can be deduced therefrom that the high-pressure homogenization has resulted in the dispersion of these proteins in the aqueous vehicle.

An assay of proteins contained in the suspension, before and after homogenization, was carried out in accordance with the method described above. The result, in weight of proteins assayed in a suspension of 100 mg of peanut seeds, is shown on FIG. 3.

It is observed thereon that, after homogenization, for the same amount of initial weight of peanut seed, an amount of proteins which is 42% higher than before high-pressure homogenization is assayed in the suspension. This result clearly demonstrates that the high-pressure homogenization results in substantial solubilization of the proteins initially contained in the particles of the ground peanut seed material.

The proteins contained in the suspension, respectively after grinding and before homogenization, and after high-pressure homogenization, were separated on an SDS-PAGE polyacrylamide gel, according to the method indicated above. After staining, the gel shown on FIG. 4 is obtained. On this gel, Lane 1 corresponds to a molecular weight marker, Lane 2 corresponds to the proteins of the suspension before homogenization and Lane 3 corresponds to the proteins of the suspension after high-pressure homogenization. On this figure, the bands attributed to the major peanut allergens, i.e. Ara h 1 (having a molecular weight of approximately 63 kDa), Ara h 3 (acidic subunit, doublet at molecular weights of approximately 42 and 45 kDa) and Ara h 2 (doublet at molecular weights of approximately 16 and 17 kDa), have been indicated with arrows.

It is observed on this FIG. 4 that, for identical operating conditions, the intensity of the bands which correspond to the major peanut allergens Ara h 1, Ara h 2 and Ara h 3 is much more pronounced for the protein extract obtained after high-pressure homogenization than for that obtained from the ground material before homogenization. The presence, on Lane 3, of bands between 35 and 20 kDa, between 55 and 45 kDa and above 70 kDa, which are not visible on Lane 2, is also noted. It can be deduced from this that the high-pressure homogenization made it possible to release, into the aqueous vehicle, a substantial amount of proteins, and in particular of the major peanut allergens Ara h 1, Ara h 2 and Ara h 3.

The high-pressure homogenization therefore made it possible to significantly improve the availability and the degree of solvation of the storage proteins contained in the peanut seeds, and to by the same token increase their susceptibility to subsequently undergoing a treatment, in particular a biological treatment, aimed at denaturing them or degrading them.

### EXAMPLE B

### Preparation of Antibodies Directed Against the Allergenic Peanut Proteins Ara h 1, Ara h 2 and Ara h 3

In order to quantify the major-allergen content of the homogenate obtained in example A, antibodies directed against the allergenic peanut proteins Ara h 1, Ara h 2 and Ara h 3 are prepared in the following way.

1) Purification of the Ara h 1 Protein

Raw peanut seeds are dispersed in 20 mM Tris buffer, pH 7.4. The resulting crude extract is subjected to precipitation in an aqueous 40% (w/v) ammonium sulfate ((NH₄)₂SO₄) solution. The supernatant is subjected to dialysis against a 20 mM phosphate buffer, pH 7, through a membrane with an exclusion limit of 3.5 kDa.

A protein extract containing predominantly Ara h 1 is obtained, and 2% by volume of polyvinylpolypyrrolidone (PVPP) are added thereto.

The Ara h 1 protein is then purified by means of a sepharose column to which concanavalin A is grafted. This lectin makes it possible to bind carbohydrate units, these same units being on the Ara h 1 protein. The binding is carried out in a 20 mmol·l⁻¹ Tris buffer, pH 7.4, supplemented with 0.5 mol·L⁻¹ of NaCl, 1 mmol·l⁻¹ of MnCl₂ and CaCl₂. The elution is carried out in the same buffer, supplemented with 200 mmol·l⁻¹ of glucose.

The residual concanavalin A is in the fractions recovered. In order to eliminate it and to increase the Ara h 1 purity, the fractions are combined and dialyzed for 48 h against 20 mmol·l⁻¹ Tris buffer, pH 7.4, in order to firstly eliminate the glucose which prevents binding of the concanavalin A to dextran.

The samples are then passed over a Sephadex G-25 column in a closed circuit for 24 h at 4° C., at a flow rate of 0.5 ml/min. The concanavalin A binds to the dextran units, and the eluate contains exclusively Ara h 1.

The identity of this protein and its state of purity are verified by SDS-PAGE and characterization of the peptide fractions obtained after tryptic hydrolysis, by mass spectrometry using a MALDI-TOF spectrometer.

2) Purification of the Ara h 2 Protein

Raw peanut seeds are dispersed in 20 mM Tris buffer, pH 7.4, supplemented with 150 mM sodium chloride (NaCl). The resulting crude extract is subjected to defatting with chloroform, and then the crude extract thus defatted is subjected to dialysis against a 20 mM Tris buffer, pH 8, through a membrane with an exclusion limit of 3.5 kDa.

A protein extract containing predominantly Ara h 2 is obtained.

The Ara h 2 protein is then purified from this extract on a 5 ml HiTrap® Q FF column (Amersham), an anionic column which makes it possible to separate the proteins according to their charge, at a slightly basic pH.

The binding takes place via ionic interaction, and the elution is carried out with an increasing NaCl gradient. The Ara h 2 protein is eluted at an NaCl concentration of 240 mmol·l⁻¹. The fractions recovered at the column outlet are then dialyzed against a 20 mmol·l⁻¹ Tris buffer, pH 7.4.

The identity of the Ara h 2 protein and its state of purity are verified by SDS-PAGE and characterization of the peptide fractions obtained after tryptic hydrolysis, by mass spectrometry using a MALDI-TOF spectrometer.

3) Purification of the Ara h 3 Protein

Raw peanut seeds are defatted with petroleum ether in a Soxhlet extractor, and then dispersed in a 20 mM Tris buffer, pH 8.

A protein extract containing predominantly Ara h 3 is obtained.

The Ara h 3 protein is then purified from this extract in two steps, on two distinct columns.

The first column is the one described for the Ara h 2 purification above, i.e. a 5 ml anionic HiTrap® Q FF column. The conditions used are the same as for the Ara h 2 purification above, apart from the fact that the elution of Ara h 3 occurs at an NaCl concentration of 400 mmol·l⁻¹.

Following this passage over the first column, and after verification by separation of the proteins by SDS-PAGE, the fractions containing Ara h 3 are combined and dialyzed against a 50 mmol·l⁻¹ phosphate buffer, pH 7.0, for 48 h at 4° C.

The final separation of Ara h 3 from the other proteins eluted at 400 mmol·l⁻¹ NaCl on 5 ml HiTrap® Q FF is carried out by chromatography on a 5 ml HiTrap® phenyl HP column (Amersham), said chromatography being termed “hydrophobic”. For the binding and the elution of the proteins on this type of column, the hydrophobicity of the proteins, which is affected by the more or less significant concentration of chaotropic salts ((NH₄)₂SO₄ for example) is exploited. For this, following the dialysis, a 2.5 mol·l⁻¹ solution of (NH₄)₂SO₄ is added to the sample in order to obtain a final (NH₄)₂SO₄ concentration of 1 mol·l⁻¹. The sample is then bound to the HiTrap® phenyl HP column and, after washing, the elution is carried out with a decreasing (NH₄)₂SO₄ salt gradient in 50 mM phosphate buffer, pH 7.0.

The proteins contained in the recovered fractions are then precipitated with trichloroacetic acid and separated on an SDS-PAGE gel in order to verify their purity.

The identity of the Ara h 3 protein and its state of purity are verified by SDS-PAGE and characterization of the peptide fractions obtained after tryptic hydrolysis, by mass spectrometry using a MALDI-TOF spectrophotometer.

4) Immunization of Rabbits

For each of the three allergenic proteins purified, the production of polyclonal antigens is carried out by immunizing two New Zealand rabbits. The immunization program is spread out over 63 days, with 4 injections of 150 to 300 μg of purified proteins taken up in complete Freund's adjuvant. Three samples are taken in order to monitor the production of the desired antibodies: on D0 for the verification of the nonreactivity of the preimmune serum, on D49 and on D63 for monitoring the immune response and the choice of whether or not to completely bleed out the rabbits.

Once it has been decided to totally bleed out the rabbits, the latter are sacrificed within a period not exceeding 40 days after the 63-day immunization program.

The specificity and the sensitivity of the sera obtained, for the associated allergenic protein, is verified by Western blot analyses, against a total peanut extract.

### EXAMPLE C

### Treatment of the Homogenate of Example a with Microorganisms

The homogenate obtained in example A is subjected to a fermentation respectively with each of the following probiotic microorganisms: Aspergillus oryzae, Rhizopus oligosporus, Bacillus subtilis.

At the end of this fermentation, the proteins contained in the homogenate thus obtained are extracted, assayed and separated by SDS-PAGE. They are then analyzed by Western blot and ELISA assay (Enzyme-Linked ImmunoSorbent Assay), in order to evaluate their degree of allergenicity.

1) Materials and Methods

Culturing of Microorganisms

Aspergillus oryzae and Rhizopus oligosporus are grown on a PDA (potato dextrose agar) medium (for one liter: 4 g potato infusion; 20 g dextrose, 15 g agar—sterilized in an autoclave for 15 minutes at 121° C./1 bar) on a petri dish at 37° C., in a humid atmosphere (95% relative humidity) for 7 days.

Bacillus subtilis is cultured in a CASO (casein tryptic soy) medium (for one liter: casein peptone 17.0 g/l; soymeal peptone 3.0 g/l; D(+)-glucose 2.5 g/l; sodium chloride 5.0 g/l; dipotassium phosphate 2.5 g/l—sterilized in an autoclave for 15 minutes at 121° C./1 bar) at 37° C. for 12 hours.

Fermentation

10 ml of homogenate are treated, in a 100 ml Erlenmeyer flask.

For Aspergillus oryzae and Rhizopus oligosporus, the pH of the homogenate is adjusted to 4.5 with acetic acid. The spores grown on a petri dish are harvested using sterile water supplemented with a few drops of Tween 20. After detachment of the spores from the culture medium using a glass rake, the suspension is filtered through Miracloth in order to keep only the spores and to separate them from the mycelium. The suspension is vortexed and directly counted under a microscope using a counting cell (Malassez cell). The spores are added to the homogenate, in a proportion of 1×10⁶ spores/ml, and then the resulting medium is heated at a temperature of 100° C. for 10 minutes, and then left to cool to ambient temperature. The culture is fermented in an aerated system with orbital shaking (at a speed of 50 revolutions/minute), at a temperature of 37° C., for 72 hours.

The Bacillus subtilis bacteria are cultured in the corresponding culture media until an optical density of 0.5 at 600 nm is obtained (12 hours at 37° C.). The homogenate is heated at 100° C. for 10 minutes and then cooled to ambient temperature. 2% (w/v) maltose is also added thereto. The bacteria are inoculated into the homogenate at a concentration of 50% (v/v). The culture is then fermented without shaking, at a temperature of 37° C., for 72 hours.

Protein Extraction after Homogenate Fermentation

After a given fermentation time, 1.5 ml of the fermentate obtained are placed in a 2 ml Eppendorf tube, and centrifuged at 16 100×g for 10 minutes at 4° C. The upper lipid layer is removed and the supernatant is taken and stored at −20° C. until analysis. It is hereinafter denoted “Supernatant”.

The pellet is resuspended in 1 ml of 20 mM Tris buffer, pH 8.5, and the solution is subjected to agitation for 1 h at ambient temperature on a mixer wheel, at a rate of 20 rotations per minute. The solution is then centrifuged at 16 100×g for 10 minutes at 4° C. The supernatant is removed and stored at −20° C. until analysis. It is hereinafter denoted “soluble Fraction”.

The pellet is then resuspended in 1 ml of a denaturing buffer (500 μl 1.25 M Tris, pH 6.5; 500 μl glycerol; 500 μl 20% SDS; 25 μl 1 M dithiothreitol; 3475 μl H₂O) in order to solubilize the proteins that might have aggregated during any prior treatment step. The solution is heated for 5 minutes at 100° C., and centrifuged at 16 100×g for 10 minutes at 4° C. The supernatant is removed and stored at −20° C. until analysis. It is hereinafter denoted “insoluble Fraction”.

The untreated raw peanut is subjected to the same protein extraction steps.

Assaying of Proteins

The various fractions extracted (Supernatant, soluble Fraction and insoluble Fraction) are subjected to a protein assay.

The Supernatant and the soluble Fraction are diluted to 1/10 in ultrapure water. The insoluble Fraction is diluted to 1/10 in a 50 mM iodoacetamide solution and heated at 37° C. for 15 minutes (which makes it possible to oxidize the dithiothreitol and not to interfere with the BCA assay reagents). The protein assay is carried out using the BCA kit from Pierce, on a 96-well flat-bottom microplate. The standard range is a solution of BSA ranging from 0 mg/ml to 2 mg/ml.

After incubation of the protein solution (25 μl after dilution) and of the Pierce reagent (200 μl) for 30 minutes at 37° C., the absorbance is read using a spectrophotometric reader at a wavelength of 562 nm.

The protein concentrations for the various fractions obtained are calculated from the standard range.

Gel Separation of Proteins

The previously extracted proteins are separated on polyacrylamide gels under denaturing conditions. The gels are formed according to the compositions indicated in the example A above.

The protein solutions are loaded at equal concentrations (20 μg per well) and the dilutions are calculated from the BCA assay. The dilutions are brought back to a volume of 20 μl, with water as diluent. For the Supernatant and soluble Fraction fractions, 4 μl of a loading buffer solution (2% SDS; 0.125 M Tris; 10% glycerol; 5% β-mercaptoethanol, a few crystals of bromophenol blue) are added to these 20 μl, and the mixtures are heated for 5 minutes at 100° C. before being loaded onto the gel. For the insoluble Fractions, 4 μl of a solution (0.125 M Tris; 10% glycerol, a few crystals of bromophenol blue) are added to these 20 μl, and the mixtures are directly loaded onto the gel.

The proteins separated on gels are then stained according to the protocol indicated in example A above.

Western Blot of the Protein Fractions after Fermentation

For all the fractions (Supernatant, soluble Fraction and insoluble Fraction), after migration of the proteins on an SDS-PAGE electrophoresis gel as indicated above, the gel is not stained, and the proteins are electrotransferred from this gel onto a nitrocellulose membrane in semi-dry mode, in a transfer buffer (48 mM Tris, 39 mM glycine, 20% (v/v) methanol) at 20 volts for 20 minutes (TransBlot® Turbo®, Biorad®). The membrane is then stained in a solution containing 0.2% Ponceau red in order to verify the efficiency of the transfer. After destaining in 1× phosphate buffered saline (PBS) (for 1 liter: 8 g NaCl, 0.2 g KCl, 1.44 g Na₂HPO₄, 0.24 g KH₂PO₄, pH 7.4). The potential binding sites not used on the membrane are saturated with a solution of PBS buffer supplemented with 5% (w/v) of skimmed milk powder, overnight at 4° C.

The membrane is then exposed to a primary antibody specific for the protein of interest, obtained in example B: the primary antibody (pool of rabbit sera: anti-Ara h 1 diluted to 1:40 000, anti-Ara h 2 diluted to 1:5000, anti-Ara h 3 diluted to 1:10 000, dilutions in the saturation buffer) is deposited on the membrane for 2 hours in a humid chamber at ambient temperature. The membrane is then washed for 3 times 10 minutes in the saturation buffer with agitation (PBS, 5% (w/v) skimmed milk, 0.1% Tween 20 (v/v)) and then incubated for 1 hour with a secondary antibody (anti-rabbit (IgG) coupled to horseradish peroxidase (diluted to 1:2000 in the saturation solution).

After 2 washes in PBS, 0.1% Tween 20, and two washes in PBS alone, the membranes are incubated with a substrate generating a chemiluminescent reaction, ECL Plus® (Amersham), for 1 minute, and the chemiluminescent signal obtained is recorded with a camera.

ELISA Assay

The ELISA assay makes it possible to quantify the residual allergens after the fermentation by the microorganisms, in each of the Supernatant, soluble Fraction and insoluble Fraction fractions. This assay is carried out in triplicate.

All the samples are diluted in PBS. Dilutions of the various extracts (Supernatant, soluble Fraction and insoluble Fraction), and also a crude extract of untreated peanut (control), are deposited in a 96-well plate, in a proportion of 50 μl per well, and at various concentrations of between 0 and 100 ng/μl for the detection with the anti-Ara h 1 antibody, 0 and 250 ng/μl for anti-Ara h 2, and anti-Ara h 3 with regard to the Supernatant and soluble Fraction fractions, and between 0 and 600 ng/μl for the insoluble Fraction, whatever the antibody used for the detection.

After this first deposit, the plate is incubated at 4° C. overnight. After incubation, the plate is washed three times (200 μl/well) with PBS. The wells are then saturated with a solution of PBS, 1% (w/v) BSA and 0.1% (v/v) Tween (100 μl per well), for one hour at ambient temperature. The plates are turned upside down and the wells emptied, and the various sera are then incubated (anti-Ara h 1 diluted to 1:10 000, anti-Ara h 2 diluted to 1:5000, anti-Ara h 3 diluted to 1:10 000 in PBS/Tween/BSA) for 2 h at ambient temperature, with agitation (50 μl/well). The plates are then turned upside down and the wells emptied and washed 3 times with a PBS/Tween/BSA solution (200 μl/well).

The secondary antibody (anti-rabbit IgG coupled to alkaline phosphatase) is then added, in a proportion of 50 μl per well, after dilution to 1:2000 in PBS/Tween/BSA, and the plate is incubated for 1 hour at ambient temperature. The wells are then rinsed three times with PBS/Tween/BSA (200 μl per well). The substrate added is 4-nitrophenyl phosphate (pNPP, Sigma), in a proportion of 100 μl per well. The plate is incubated at ambient temperature for 30 minutes in the dark with agitation. The absorbance is then read at 450 nm in a spectrophotometer for microplates.

2) Results

2.1) Fermentation by Rhizopus oligosporus

After 72 hours of fermentation by Rhizopus oligosporus, and protein extraction, according to the protocol indicated above, the proteins of each fraction obtained (Supernatant, soluble Fraction and insoluble Fraction) are separated by SDS-PAGE electrophoresis. The control used is a protein extract of raw peanut seeds.

The gel obtained after staining is shown on FIG. 5.

It is observed thereon that, for all the protein fractions obtained after fermentation of the homogenate (Lanes 3 to 5), compared with the crude extract of untreated peanut seeds (Lane 2), the bands corresponding to the major peanut allergens (approximately 63 kDa for Ara h, approximately 42 and 45 kDa for Ara h 3 and approximately 16 and 17 kDa for Ara h 2) have disappeared. These proteins are no longer present in the fermentate obtained.

The results of the analysis by Western blot of these same fractions is shown on FIG. 6. For all the extracts obtained after treatment by fermentation (Lanes 2 to 4), no control band for the binding of proteins to any one of the three anti-Ara h 1, anti-Ara h 2 or anti-Ara h 3 antibodies is observed thereon.

The results obtained by ELISA assay, for each of the anti-Ara h 1, anti-Ara h 2 or anti-Ara h 3 antibodies, after respectively 24, 48 and 72 hours of fermentation, are shown in table 1 hereinafter.

TABLE 1
Ara h 1, Ara h 2 and Ara h 3 content of the protein extracts after
fermentation of the homogenate of example A by Rhizopus oligosporus, determined by
ELISA assay

| | Fermentation | Ara h 1 | % | Ara h 2 | % | Ara h 3 | % |
|---|---|---|---|---|---|---|---|
| | time | A | Ara h 1 | A | Ara h 2 | A | Ara h 3 |
| supernatant | untreated | 302.7 | | 337 | | 365 | |
| | 24 h | 55 | −82% | 94 | −72% | 79 | −78% |
| | 48 h | 17 | −94% | 58 | −83% | 46 | −87% |
| | 72 h | 10 | −97% | 14 | −96% | 11 | −97% |
| soluble | untreated | 602.67 | | 337 | | 365 | |
| Fraction | 24 h | 90 | −85% | 85 | −75% | 92 | −75% |
| | 48 h | 48 | −92% | 48 | −86% | 64 | −82% |
| | 72 h | 18 | −97% | 13 | −96% | 16 | −96% |
| insoluble | untreated | 121.33 | | 190 | | 183.33 | |
| Fraction | 24 h | 78 | −36% | 74 | −61% | 92 | −50% |
| | 48 h | 34 | −72% | 42 | −78% | 36 | −80% |
| | 72 h | 5 | −96% | 9 | −95% | 8 | −96% |

where A represents the absorbance at 450 nm

Compared with the protein extract obtained from untreated peanut seeds, a significant decrease in the content of major allergenic proteins Ara h 1, Ara h 2 and Ara h 3 is observed as early as after 24 h of fermentation. For all the extraction fractions, after 72 h of fermentation, this decrease is greater than or equal to 95% compared with the untreated peanut seeds.

All the results above clearly show that the fermentate obtained after grinding raw peanut seeds, ultra high-pressure homogenization and fermentation by Rhizopus oligosporus, in accordance with a particular embodiment of the method according to the invention, exhibits a greatly reduced degree of allergenicity compared with the starting untreated raw peanut. The main allergenic peanut proteins Ara h 1, Ara h 2 and Ara h 3 were efficiently extracted from the initial solid matrix by the ultra high-pressure homogenization, and efficiently degraded by the microorganism. After 72 hours of fermentation, the allergenicity of the initial matrix was reduced by at least 95%.

2.2) Fermentation by Aspergillus oryzae

For this microorganism, tests were carried out, by applying the experimental protocols above, firstly using raw peanut seeds and secondly using roasted peanut seeds. The protocol described in example A was applied in identical fashion to the latter, so as to obtain a “roast peanut” homogenate.

The roasted peanut seeds were obtained in accordance with the teaching of document FR-A-2 713 447.

After 72 hours of fermentation by Aspergillus oryzae, and protein extraction, according to the protocol indicated above, the proteins of each fraction obtained (Supernatant, soluble Fraction and insoluble Fraction) are separated by SDS-PAGE electrophoresis. The control used is a protein extract of raw peanut seeds.

The gel obtained after staining is shown in FIG. 7.

It is observed that, compared with the crude extract of untreated peanut seeds (Lane 2), for all the protein fractions obtained after fermentation of the homogenate, whether the latter was obtained from raw peanut seeds (Lanes 3 to 5) or roasted peanut seeds (Lanes 6 to 8), the bands corresponding to the major peanut allergens (approximately 63 kDa for Ara h, approximately 42-45 kDa for Ara h 3 and approximately 16 and 17 kDa for Ara h 2) have disappeared. These proteins are no longer present in the fermentates obtained, or are present in very small amount.

The result of the analysis by Western blot of these same fractions is shown on FIG. 8. It is clearly observed thereon, for all the extracts obtained after treatment by fermentation of raw peanut seeds (Lanes 3 to 5) and of roasted peanut seeds (Lanes 6 to 8), that a much smaller amount of proteins interact with the anti-Ara h 1, anti-Ara h 2 or anti-Ara h 3 antibodies, compared with the extract obtained from untreated raw peanut seeds (Lane 2).

The results obtained by ELISA assay, for each of the anti-Ara h 1, anti-Ara h 2 or anti-Ara h 3 antibodies, after 72 hours of fermentation, are shown in table 2 hereinafter.

TABLE 2
Ara h 1, Ara h 2 and Ara h 3 content of the protein extracts after
fermentation of the homogenate of example A (raw seeds) and of a
homogenate obtained, by means of a similar protocol, from roasted
peanut seeds, using Aspergillus oryzae, determined by ELISA assay

| | | Ara h 1 | % | Ara h 2 | % | Ara h 3 | % |
|---|---|---|---|---|---|---|---|
| | | A | Ara h 1 | A | Ara h 2 | A | Ara h 3 |
| Supernatant | untreated | 450 | | 493 | | 372 | |
| | raw | | | | | | |
| | treated raw | 26 | −94% | 24 | −95% | 28 | −92% |
| | untreated | 181 | | 128 | | 134 | |
| | roasted | | | | | | |
| | treated | 26 | −86% | 23 | −82% | 21 | −84% |
| | roasted | | | | | | |
| soluble | untreated | 450 | | 493 | | 372 | |
| Fraction | raw | | | | | | |
| | treated raw | 12 | −97% | 21 | −96% | 16 | −96% |
| | untreated | 181 | | 128 | | 134 | |
| | roasted | | | | | | |
| | treated | 30 | −83% | 18 | −97% | 27 | −80% |
| | roasted | | | | | | |
| insoluble | untreated | 539 | | 273 | | 280 | |
| Fraction | raw | | | | | | |
| | treated raw | 47 | −91% | 31 | −89% | 24 | −91% |
| | untreated | 301 | | 293 | | 175 | |
| | roasted | | | | | | |
| | treated | 67 | −78% | 65 | −78% | 46 | −74% |
| | roasted | | | | | | |

where A represents the absorbance at 450 nm

Compared with the protein extract obtained from untreated peanut seeds, a very significant decrease in the content of major allergenic proteins Ara h 1, Ara h 2 and Ara h 3 in the protein extracts obtained both from raw peanut seeds and from treated peanut seeds is observed after 72 h of fermentation by Aspergillus oryzae.

These results demonstrate that the fermentates obtained after grinding raw or roasted peanut seeds, ultra high-pressure homogenization and fermentation by Aspergillus oryzae, in accordance with a particular embodiment of the method according to the invention, exhibit a greatly reduced degree of allergenicity compared with the untreated raw peanut. The main allergenic peanut proteins Ara h 1, Ara h 2 and Ara h 3 were efficiently extracted from the initial solid matrix by the high-pressure homogenization, and efficiently degraded by the microorganism. In particular, for the raw seeds, after 72 hours of fermentation, the allergenicity of the initial matrix was reduced by at least 90%.

2.3) Fermentation by Bacillus subtilis

After 72 hours of fermentation by Bacillus subtilis, and protein extraction, according to the protocol indicated above, the proteins of two fractions obtained (soluble Fraction and insoluble Fraction) are separated by SDS-PAGE electrophoresis. The control used is a protein extract of raw peanut seeds.

The gel obtained after staining is shown on FIG. 9.

It is observed thereon that, for the protein fractions obtained after fermentation of the homogenate (Lanes 2 to 4), compared with the crude extract of untreated peanut seeds (Lane 1), the bands corresponding to the major peanut allergens (approximately 63 kDa for Ara h, approximately 42-45 kDa for Ara h 3 and approximately 16 and 17 kDa for Ara h 2) have disappeared.

The result of the analysis by Western blot of these same fractions is shown on FIG. 10. For the extracts obtained after treatment by fermentation (Lanes 2 to 4), no control band for the binding of proteins to any one of the three anti-Ara h 1, anti-Ara h 2 or anti-Ara h 3 antibodies is observed thereon.

The results obtained by ELISA assay, for each of the anti-Ara h 1, anti-Ara h 2 and anti-Ara h 3 antibodies, after 72 hours of fermentation, are shown in table 3 hereinafter.

TABLE 3
Ara h 1, Ara h 2 and Ara h 3 content of the protein extracts after
fermentation of the homogenate of example A by Bacillus subtilis,
determined by ELISA assay

| | Ara h | % | Ara h | % | Ara h | % |
|---|---|---|---|---|---|---|
| | 1 A | Ara h 1 | 2 A | Ara h 2 | 3 A | Ara h 3 |
| untreated | 456 | | 351 | | 382 | |
| Treated | 23 | −95% | 18 | −95% | 17 | −96% |
| Supernatant | | | | | | |
| Treated | 24 | −95% | 19 | −95% | 21 | −95% |
| soluble Fraction | | | | | | |
| Treated | 12 | −97% | 15 | −96% | 13 | −97% |
| insoluble Fraction | | | | | | |

where A represents the absorbance at 450 nm

Compared with the protein extract obtained from untreated peanut seeds, a significant decrease in the content of major allergenic proteins Ara h 1, Ara h 2 and Ara h 3 is observed after 72 h of fermentation. For all the extraction fractions, this decrease is greater than or equal to 95%.

The results above clearly show that the fermentate obtained after grinding raw peanut seeds, ultra high-pressure homogenization and fermentation by Bacillus subtilis, in accordance with one particular embodiment of the method according to the invention, exhibits a greatly reduced degree of allergenicity compared with the starting untreated raw peanut. The main allergenic peanut proteins Ara h 1, Ara h 2 and Ara h 3 were efficiently extracted from the initial solid matrix by the ultra high-pressure homogenization, and efficiently degraded by the microorganism. After 72 hours of fermentation, the allergenicity of the initial matrix was reduced by at least 95%.

The description above clearly illustrates that, by virtue of its various characteristics and their advantages, the present invention achieves the objectives that it had set itself. In particular, it provides a method for preparing a hypoallergenic food from a highly allergenic solid food matrix, which is nonpolluting, and which makes it possible to retain in the food the gustative, organoleptic and nutritional properties of the starting matrix.

### LITERATURE REFERENCES

Chung S.-Y., Champagne E. T. (2007) Effects of phytic acid on peanut allergens and allergenic properties of Extracts. J. Agric. Food Chem. 55:9054-9058
Chung S.-Y., Yang W. (2008) Effects of pulsed UV-light on peanut allergens in extracts and liquid peanut butter. J. Food Chem. 73:C400
Davis P., Williams, S (1998) Protein modification by thermal processing. Allergy 53:102-105
Kato T., et al. (2000) Release of allergenic proteins from rice grains induced by high hydrostatic pressure. J. Agric. Food Chem. 48: 3124-3129
Lecluse W. J. (1979) Homogénéisateurs à haute pression. Informations Chimie 191: 1-8
Van Boxtel E. L., Koppelman S. J. et al. (2008) Determination of pepsin-susceptible and pepsin-resistant epitopes in native and heat-treated peanut allergen ara h 1. J. Agric. Food Chem. 56:2223-2230

1-12. (canceled)

13. A method for preparing a food from a particulate solid food matrix containing allergenic proteins, comprising the steps of dispersing the solid food matrix in an aqueous vehicle and treating a dispersion of the solid food matrix in the aqueous vehicle, by high-pressure homogenization, to obtain a homogenate consisting of a dispersion of allergenic proteins initially contained in the solid food matrix as a mixture with solid particles of the solid food matrix.

14. The method as claimed in claim 13, wherein the solid food matrix consists of at least one of peanut seeds or tree nuts.

15. The method as claimed in claim 13, further comprising the step of grinding the solid food matrix prior to the step of high-pressure homogenization treatment.

16. The method as claimed in claim 15, wherein the step of grinding the solid food matrix is subsequent to the dispersion of the solid food matrix in the aqueous vehicle.

17. The method as claimed in claim 13, wherein the dispersion of the solid food matrix in the aqueous vehicle comprises a ratio of a weight of the solid food matrix to a volume of the aqueous vehicle between 50:50 and 5:95.

18. The method as claimed in claim 13, wherein the dispersion of the solid food matrix in the aqueous vehicle comprises a ratio of a weight of the solid food matrix to a volume of the aqueous vehicle equal to 20:80.

19. The method as claimed in claim 13, wherein the high-pressure homogenization treatment step is performed at a pressure between 100 and 50,000 bar.

20. The method as claimed in claim 13, wherein the high-pressure homogenization treatment step is performed at a pressure of between 200 and 1000 bar.

21. The method as claimed in claim 13, wherein the high-pressure homogenization treatment step is performed at 500 bar.

22. The method as claimed in claim 13, wherein the high-pressure homogenization treatment step is performed to obtain a homogenate particle size of less than 20 μm, in terms of diameter.

23. The method as claimed in claim 13, wherein the high-pressure homogenization treatment step is performed to obtain a homogenate particle size substantially equal to 10 μm, in terms of diameter.

24. The method as claimed in claim 13, further comprising the step of treating the homogenate using a protein-degrading agent after the high-pressure homogenization treatment step.

25. The method as claimed in claim 24, wherein the protein-degrading agent is a proteolytic agent.

26. The method as claimed in claim 24, wherein the protein-degrading agent is a microorganism.

27. The method as claimed in claim 26, wherein the microorganism is a probiotic microorganism.

28. The method as claimed in claim 26, wherein the microorganism is a bacterium.

29. The method as claimed in claim 26, wherein the microorganism is a fungus.

30. The method as claimed in claim 26, further comprising the steps of inoculating the microorganism into the homogenate; and fermenting a resulting medium for a period of time sufficient to reduce an allergenicity of the allergenic proteins contained in the homogenate by at least 70%.

31. The method as claimed in claim 26, further comprising the steps of inoculating the microorganism into the homogenate; and fermenting a resulting medium for a period of time sufficient to reduce an allergenicity of the allergenic proteins contained in the homogenate by at least 90%.

32. The method as claimed in claim 30, further comprising the step of supplementing the homogenate, prior to the fermentation, with at least one of the following: sugar, starch or acid.
